(19) United States
(12) Patent Application Publication
(10) Pub. No.: US 2022/0193702 A1
(43) Pub. Date: Jun. 23, 2022

(54) ROTATING SPRINKLER HEAD

(71) Applicant: HONGFU LIU, CHANGDE (CN)

(72) Inventor: HONGFU LIU, CHANGDE (CN)

(21) Appl. No.: 17/691,052

(22) Filed: Mar. 9, 2022

(51) Int. Cl. B05B 3/02; B05B 3/12; B05B 3/06

(52) U.S. Cl. CPC B05B 3/026; B05B 3/06; B05B 3/12

(57) ABSTRACT

A rotating sprinkler head, comprising: a base, both ends of which are formed with a mounting cavity and a water inlet nozzle that are coaxially arranged and interconnected; a support seat, which is installed within the mounting cavity and forms an interference fit with the mounting cavity, a linkage hole being provided on the support seat along an axial direction; and a rotating sprinkler head, which comprises a linkage pipe, a seal assembly sleeved on one end of the linkage pipe, and four outward radiating water sprinkling pipes that are located on the other end of the linkage pipe to be integrally formed with same, one end of the linkage pipe installed with the sealing assembly being sleeved within the linkage hole. Such structure is convenient to mount and disassemble, and high in the stability of rotating water sprinkling.

### TECHNICAL FIELD

The present utility model relates to the field of water sprinkling toys, in particular to a rotating sprinkler installed on an inflatable toy.

### BACKGROUND

Inflatable toys are popular with children. At present, there are various types of inflatable toys on the market, so as to cater to children's preferences, such as inflatable toys with small animal shapes for riding, decorative inflatable toys used in suitable game scenes, and inflatable toys that can be used for playing inside after inflation and others.

However, numerous inflatable toys at present often have a single function of just playing after inflation, with less fun of playing. Especially in summer, children prefer to play in water or water occasions in summer, which can not only relieve summer heat but also increase the fun of playing.

Nowadays, inflatable toys having a water sprinkling function also appear in the market. A water inlet pipe is connected inside an inflatable toy, and a sprinkler head connected to the water inlet pipe is installed on the outer surface of the inflatable toy, so that the water sprinkling function is realized to increase the fun of playing.

However, such an inflatable toy with a water sprinkling function, since the water sprinkling direction of the sprinkler head is fixed and cannot change from time to time, still has deficiencies although having a water sprinkling function, resulting in still lacking in the fun and entertainment of playing.

### SUMMARY

In view of the deficiencies in the prior art, the present utility model provides a rotating sprinkler installed on an inflatable toy, so that when water flows into the water inlet pipe, the sprinkler head of the rotating sprinkler can automatically rotate to change the direction of water sprinkling from time to time, thus increasing the fun and entertainment of playing. The technical solution is described as follows.

A rotating sprinkler head, comprising:

a base, both ends of which are formed with a mounting cavity and a water inlet nozzle that are coaxially arranged and interconnected, wherein the mounting cavity is cylindrical and has a diameter greater than that of the water inlet nozzle;

a support seat, which is installed within the mounting cavity and forms an interference fit with the mounting cavity, wherein a linkage hole is provided on the support seat along an axial direction, and the linkage hole and the mounting cavity are interconnected; and

a rotating sprinkler head, which comprises a linkage pipe, a seal assembly sleeved on one end of the linkage pipe, and four outward radiating water sprinkling pipes that are located on the other end of the linkage pipe to be integrally formed with same, wherein the four water sprinkling pipes are arranged at equal angle intervals, one end of the linkage pipe installed with the sealing assembly is sleeved within the linkage hole, the diameter of the linkage pipe is less than the inner diameter of the linkage hole so as to form a clearance fit, and the length dimension of the linkage pipe is greater than that of the linkage hole, so that the linkage pipe passes through the linkage hole to go deep into the mounting cavity, and the diameter dimension of the sealing assembly is greater than the inner diameter dimension of the linkage hole.

Further, a connecting skirt is also formed on the base, and the connecting skirt is formed on the outer surface of the base body and extends outwardly.

Further, the seal assembly comprises a first seal ring and a second seal ring, the first seal ring has a circular cross-section, the second seal ring has a rectangular cross-section, and when the linkage pipe penetrates into the linkage hole, the second seal ring is tightly attached to the end surface of and the linkage hole, and the first seal ring seals the second seal ring and the linkage pipe.

Further, water sprinkling jackets are sleeved on all the four water sprinkling pipes, blind hole-type water receiving holes are provided on the water sprinkling jackets in the axial direction, a plurality of water sprinkling holes arranged at equal intervals are provided on the side walls of the water sprinkling jackets, the water sprinkling holes and the water receiving holes are interconnected, a receiving groove is respectively provided on the inner walls of the water receiving holes in a circumferential direction, corresponding barrier rings are provided on the water sprinkling pipes, third seal rings are provided near the sides of the barrier rings close to the water sprinkling jackets, and the outer diameter dimension of the third seal rings is greater than the inner diameter dimension of the water receiving holes.

Further, an inclined water sprinkling surface is respectively formed on the end surfaces of the water sprinkling jackets away from the water sprinkling pipes, and side sprinkling holes interconnected with the water receiving holes are defined on the water sprinkling surfaces.

Further, a plurality of water baffles arranged at equal intervals are formed on the inner walls of the water receiving holes, and the water baffles are arranged axially along the water spraying jackets and protrude toward a central axis direction.

Further, there are four water baffles arranged at equal intervals on the inner walls of the water receiving holes.

Compared with the prior art, the present utility model has the beneficial effects as follows:

according to a rotating sprinkler head disclosed in the embodiments of the present utility model, the rotating sprinkler head is mounted on the base by means of the support seat, and at the same time, the linkage pipe on the rotating sprinkler head and the linkage pipe on the support seat form a clearance fit, so that when water supply is carried out by means of an external water pipe intervening in the water inlet nozzle, water is ejected from the water sprinkling holes of the water sprinkling jackets after flowing through the mounting cavity and the linkage pipe to make the water sprinkling pipes receive the reaction force of water flow ejection, so as to make the linkage pipe rotate in the linkage hole. The technical solution provided in the present utility model is simple in structure and convenient in installation.

At the same time, a connecting skirt is also formed on the base. The connecting skirt is used for welding with an inflatable toy and can have a large contact surface with the inflatable toy, so as to be reliably connected with same.

In addition, a water sprinkling surface with an inclined surface is respectively formed on the end surfaces of the water sprinkling jackets, and side sprinkling holes on the water sprinkling surfaces can eject water flow at multiple angles, thereby increasing the fun of water sprinkling, and increasing the force received by the water sprinkling pipes, so as to improve the rotation effect.

Finally, water baffles formed along the inner walls of the water receiving holes are provided within the water sprinkling jackets. Under the condition of increasing the strength of the water sprinkling jackets, the water baffles can also block the water flow path within the water receiving holes so as to add multiple obstacles in the flowing path of water sprinkling, so that the water pressure within the water receiving holes is increased, the flow rate of water sprinkling is increased, and the force on the water sprinkling pipes is enhanced, thus further improving the rotating effect, and making more fun of the inflatable toy.

The present utility model will be further described as follows in conjunction with accompanying drawings of description and embodiments.

### BRIEF DESCRIPTION OF THE DRAWINGS

FIG. 1 is a three-dimensional structural schematic diagram of the present utility model;

FIG. 2 is an explosion diagram of the present utility model;

FIG. 3 is a section view of the present utility model;

FIG. 4 is a partial enlarged view of part A in FIG. 3; and

FIG. 5 is a section view of the water sprinkling jackets in the present utility model.

### DETAILED DESCRIPTION

In order to make the above-mentioned objects, features and advantages of the present utility model clearly understood, in conjunction with the accompanying drawings, specific embodiments of the present utility model will be described in detail as follows.

In the following embodiments, more specific details are set forth in order to fully understand the present utility model. However, the present utility model can also be implemented in other ways different from those described herein. Therefore, the present utility model is not limited to the specific embodiments disclosed below.

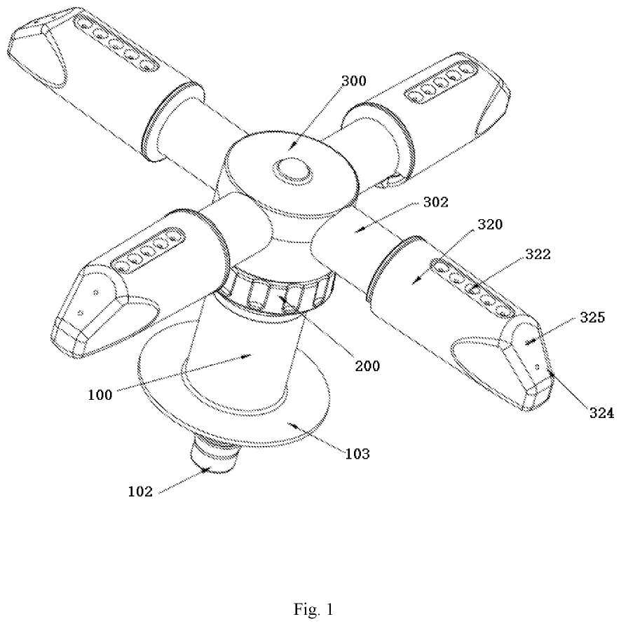

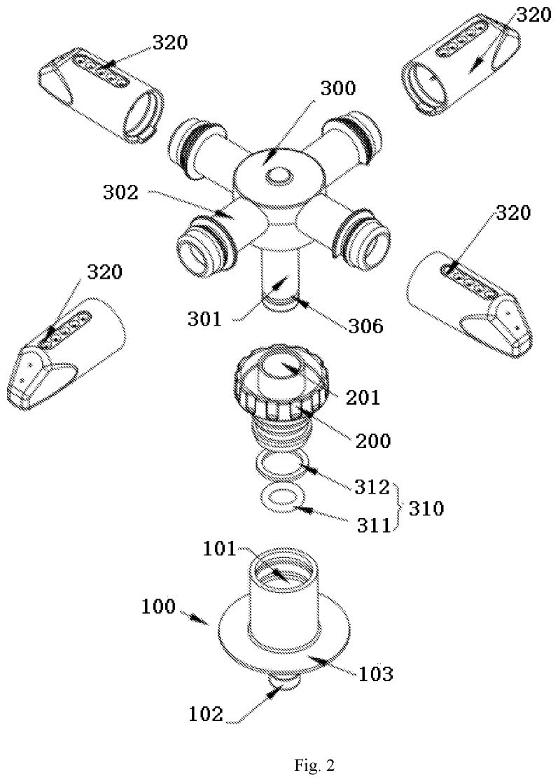

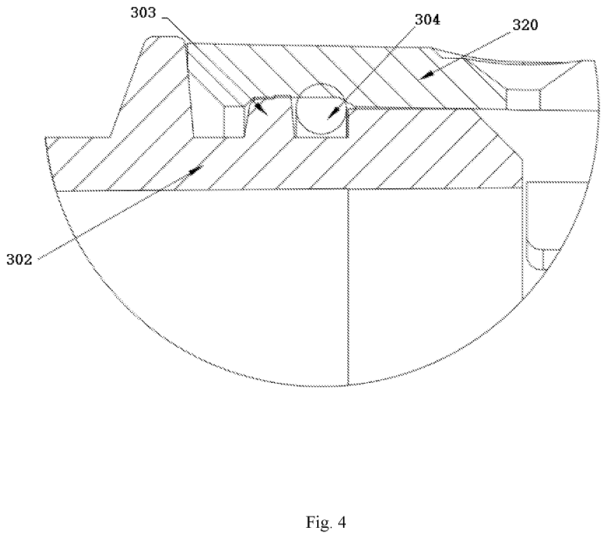

Referring to FIGS. 1-5, the embodiments of the present utility model provide a rotating sprinkler head as shown in FIGS. 1-2, comprising a base 100, on which a mounting cavity 101 and a water inlet nozzle 102 that are coaxially arranged and interconnected are provided, wherein the mounting cavity 101 and the water inlet nozzle 102 are integrally injection molded to facilitate production and processing, and the mounting cavity 101 is cylindrical and has a diameter greater than that of the water inlet nozzle 102. A support seat 200 is installed within the mounting cavity 101 by means of an interference fit, and a linkage hole 201 interconnected with the mounting cavity 101 is defined on the support seat 200 along its axial direction, wherein the size of the support seat 200 installed in the mounting cavity 101 is less than the depth of the mounting cavity 101, so as to reduce the overall size of the support seat 200 and reduce the cost of producing the support seat 200. The rotating sprinkler head further comprises a rotating sprinkler head 300, of which one end defines a linkage pipe 301, and the other end defines four outward radiating water sprinkling pipes 302 that are integrally formed. At the same time, a seal assembly 310 is also installed on one end of the linkage pipe 301 away from the water sprinkling pipes 302, and the length dimension of the linkage pipe 301 is greater than that of the linkage hole 201, so that when the linkage pipe 301 penetrates within the linkage hole 201, one end installed with the seal assembly 310 penetrates through the linkage hole 201 and is located within the mounting cavity 101. At the same time, the diameter of the linkage pipe 301 is less than the inner diameter of the linkage hole 201, so as to form a clearance fit.

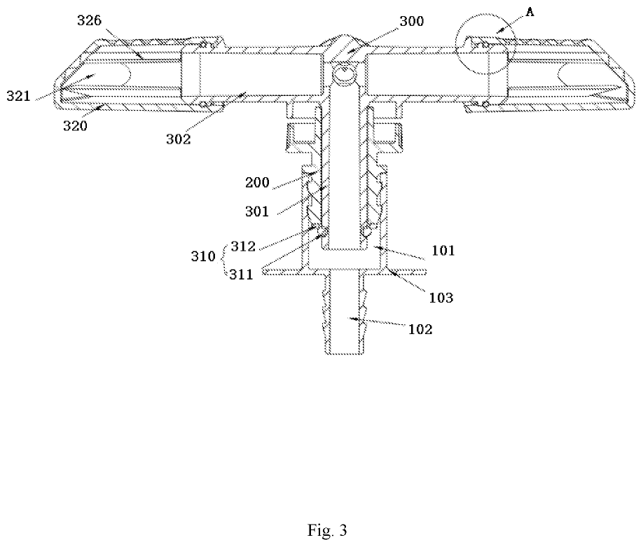

When in use, as shown in FIG. 3, the linkage pipe 301 of the rotating sprinkler head 300 penetrates within the linkage hole 201 of the support seat 200, and will not be disengaged within the linkage hole 201 by means of the seal assembly 310 fitted on the linkage pipe 301. At the same time, the support seat 200 is installed within the mounting cavity 101 of the base 100 by means of an interference fit. The water inlet nozzle 102 located on the base 100 is connected to an external water pipe to transfer water into the base 100, and water flow enters into the linkage pipe 301 after passing through the mounting cavity 101 of the base 100, and is ejected from the four water sprinkling pipes 302. In the process of water flow ejection through the four water sprinkling pipes 302, the reaction force of the water flow ejection causes the linkage pipe 301 of the rotating sprinkler head 300 to rotate within the linkage hole 201, so as to realize rotating water sprinkling. And when the rotating sprinkler head is fixedly connected together to the inflatable toy by bonding or the like, the rotating water sprinkling can be realized, and the fun of the toy is enhanced.

In the embodiments, as shown in FIGS. 2-3, a connecting skirt 103 is also formed on the base 100. The connecting skirt 103 is formed on the outer surface of the base 100 and extends outwardly. At the same time, the connecting skirt 103 and the mounting cavity 101 on the base 100 and the water inlet nozzle 102 are integrally injection molded, and the connecting skirt 103 is used for welding with the inflatable toy, so that the base 100 is more conveniently installed on the inflatable toy.

In the embodiments, as shown in FIG. 2, the seal assembly 310 comprises a first seal ring 311 and a second seal ring 312, wherein the first seal ring 311 has a circular cross-section, and the second seal ring 312 has a rectangular cross-section. When the linkage pipe 301 passes through the linkage hole 201 and extends into the mounting cavity 101, the second seal ring 312 is deformed close to the end surface of and the linkage hole 201, while the first seal ring 311 and the second seal ring 312 seal each other, so that the first seal ring 311 seals the gap between the second seal ring 312 and the linkage pipe 301. Correspondingly, a mounting ring groove 306 for receiving the first seal ring 311 and the second seal ring 312 is provided at the end of the linkage pipe 301. Specifically, the first seal ring 311 and the second seal ring 312 are placed within the mounting ring groove 306 by being stacked on top of each other, and after the linkage pipe 301 passes through the linkage hole 201, since the length of the linkage pipe 301 is greater than that of the linkage hole 201, the seal assembly 310 installed in the mounting ring groove 306 is located within the mounting cavity 101. At the same time, for sealing, the mounting ring groove 306 is located at the position corresponding to the end position of the linkage hole 201, so that the second seal ring is tightly attached to the end of the linkage hole 201. In addition, the first seal ring 311 seals the gap between the second seal ring 312 and the linkage pipe 301, and when the rotating sprinkler head 300 rotates under the action of water flow, that is, in the case of the linkage pipe 301 rotating within the linkage hole 201, the linkage pipe 301 can be close to the end of the linkage hole 201 by means of the second seal ring 312 with a rectangular cross-section. Since the cross-section of the second seal ring 312 is rectangular and the contact thereof with the end of the linkage hole 201 is a surface contact, the second seal ring 312 seals the linkage hole 201. Meanwhile, the first seal ring 311 and the second seal ring 312 are in contact with each other, so as to seal the gap between the second seal ring 312 and the linkage pipe 301, so that when the linkage pipe 301 rotates within the linkage hole 201, a good sealing effect is also provided between the linkage pipe 301 and the linkage hole 201, which can prevent water from seeping from the gap between the linkage pipe 301 and the linkage hole 201.

In the embodiments, as shown in FIGS. 2-4, rotation is achieved in order to provide better water sprinkling effect and make the rotating sprinkler head 300 subjected to a large force of water flow. Water sprinkling jackets 320 are installed on all the four water sprinkling pipes 302, wherein blind hole-type water receiving holes 321 are diffracted on the water sprinkling jackets 320 in the axial direction, a plurality of water sprinkling holes 322 arranged in parallel in the axial direction are provided on the side walls of the water sprinkling jackets 320, and the water sprinkling holes 322 and the water receiving holes 321 are interconnected, so that water within the water receiving holes 321 are ejected from the water sprinkling holes 322. Meanwhile, in the ejecting process, the water sprinkling jackets 320 receive the reaction force of the water flow, thereby achieving the rotation of the rotating sprinkler head 300. In order to better make the rotating sprinkler head 300 rotate, the water sprinkling jackets 320 installed on the four water sprinkling pipes 302 are provided with substantially the same direction, that is, the water sprinkling holes 322 on the water sprinkling jackets 320 face substantially the same direction, so as to ensure that the rotating sprinkler head 300 has a good rotating effect. Meanwhile, a receiving groove 323 is respectively provided on the inner walls of the water receiving holes 321 in a circumferential direction, and barrier rings 303 corresponding to the receiving grooves 323 are provided on the water sprinkling pipes 302, wherein third seal rings 304 are fitted near the sides of the barrier rings 303. Specifically, the third seal rings 304 are fitted on the water sprinkling pipes 302 on one sides of the barrier rings 303 near the ports of the water sprinkling pipes 302, and the outer diameter dimension of the third seal rings 304 is greater than the inner diameter dimension of the water receiving holes 321, so that when the water sprinkling jackets 320 are fitted on the water sprinkling pipes 302, the third seal rings 304 and the water sprinkling pipes 302 form an interference fit, and the third seal rings 304 seal the water sprinkling jackets 320 and the water sprinkling pipes 302. Further, in the process of fitting the water sprinkling pipes 302, the water sprinkling jackets 320 first contact the third seal rings 304, and during fitting, the third seal rings 304 are pushed, and the barrier rings 303 limit the third seal rings 304 to prevent a large displacement of the third seal rings 304 to affect the sealing effect, until the barrier rings and the third seal rings 304 are accommodated within the receiving grooves 323, so as to complete the installation of the water sprinkling jackets 320.

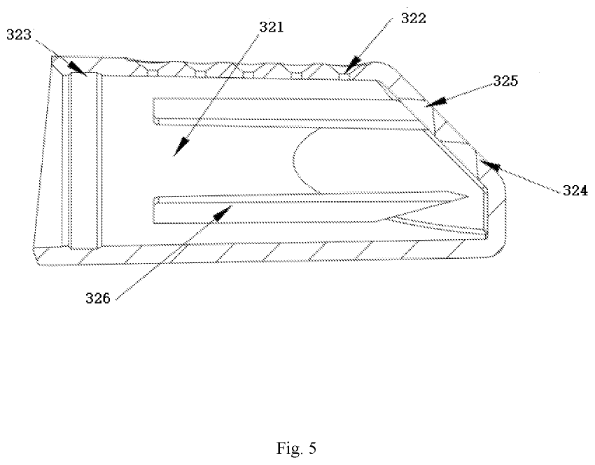

In the embodiments, as shown in FIG. 5, an inclined water sprinkling surface 423 is respectively formed on the end surfaces of the water sprinkling jackets 320 away from the water sprinkling pipes 302, and a plurality of side sprinkling holes 325 interlinked with the water receiving holes 321 are defined on the water sprinkling surfaces 324, so that during the water sprinkling of the rotating sprinkler head 300, multi-angle water sprinkling can be achieved, water sprinkling angle and effect are increased, and the fun of the inflatable toy is increased.

In the embodiments, as shown in FIG. 5, a plurality of water baffles 326 arranged at equal intervals are formed on the inner walls of the water receiving holes 321, and the water baffles 326 are arranged in the axial direction of the water spraying jackets 320 and protrude toward a central axis direction. In the present embodiment, there are four water baffles 326 spaced ninety degrees on the inner walls of the water receiving holes 321. When the water flow enters into the water receiving holes 321 and is ejected from the water sprinkling holes 322 and the side sprinkling holes 325, the water flow is separated by the block of the water baffles 326, so that the water flow path within the water receiving holes 321 is blocked to make a certain accumulation of water within the water receiving holes 321, so as to increase the water pressure within the water receiving holes 321, thus water can be more quickly ejected from the water sprinkling holes 322 and the side sprinkling holes 325 to provide a large reaction force of water sprinkling on the water sprinkling pipes 302, so as to further improve the effect of rotation.

Meanwhile, a plurality of water baffles 326 provided within the water receiving holes 321 can increase the strength of the water sprinkling jackets 320, and the water sprinkling jackets 320 are fitted on the water sprinkling holes 322. Ends of the water baffles 326 are used for realizing a limit with ends of the water sprinkling pipes 302, so as to limit the depth of the water sprinkling jackets 320 fitted on the water sprinkling pipes 302, thus further ensuring the installation accuracy of the water sprinkling jackets 320 and the water sprinkling pipes 302.

For those skilled in the art, various other corresponding changes and modifications can be obtained according to the structure and principles disclosed in the present utility model, and all such changes and modifications belong to the scope of protection of the present utility model.

1. A rotating sprinkler head, comprising:
a base, both ends of which are formed with a mounting cavity and a water inlet nozzle that are coaxially arranged and interconnected, wherein the mounting cavity is cylindrical and has a diameter greater than that of the water inlet nozzle;
a support seat, which is installed within the mounting cavity and forms an interference fit with the mounting cavity, wherein a linkage hole is provided on the support seat along an axial direction, and the linkage hole and the mounting cavity are interconnected; and
a rotating sprinkler head, which comprises a linkage pipe, a seal assembly sleeved on one end of the linkage pipe, and four outward radiating water sprinkling pipes that are located on the other end of the linkage pipe to be integrally formed with same, wherein the four water sprinkling pipes are arranged at equal angle intervals, one end of the linkage pipe installed with the sealing assembly is sleeved within the linkage hole, the diameter of the linkage pipe is less than the inner diameter of the linkage hole so as to form a clearance fit, and the length dimension of the linkage pipe is greater than that of the linkage hole, so that the linkage pipe passes through the linkage hole to go deep into the mounting cavity, and the diameter dimension of the sealing assembly is greater than the inner diameter dimension of the linkage hole.

2. The rotating sprinkler head according to claim 1, wherein a connecting skirt is also formed on the base, and the connecting skirt is formed on the outer surface of the base body and extends outwardly.

3. The rotating sprinkler head according to claim 1, wherein the seal assembly comprises a first seal ring and a second seal ring, the first seal ring has a circular cross-section, the second seal ring has a rectangular cross-section, and when the linkage pipe penetrates into the linkage hole, the second seal ring is tightly attached to the end surface of and the linkage hole, and the first seal ring seals the second seal ring and the linkage pipe.

4. The rotating sprinkler head according to claim 1, wherein water sprinkling jackets are sleeved on all the four water sprinkling pipes, blind hole-type water receiving holes are provided on the water sprinkling jackets in the axial direction, a plurality of water sprinkling holes arranged at equal intervals are provided on the side walls of the water sprinkling jackets, the water sprinkling holes and the water receiving holes are interconnected, a receiving groove is respectively provided on the inner walls of the water receiving holes in a circumferential direction, corresponding barrier rings are provided on the water sprinkling pipes, third seal rings are provided near the sides of the barrier rings close to the water sprinkling jackets, and the outer diameter dimension of the third seal rings is greater than the inner diameter dimension of the water receiving holes.

5. The rotating sprinkler head according to claim 4, wherein an inclined water sprinkling surface is respectively formed on the end surfaces of the water sprinkling jackets away from the water sprinkling pipes, and side sprinkling holes interconnected with the water receiving holes are defined on the water sprinkling surfaces.

6. The rotating sprinkler head according to claim 4, wherein a plurality of water baffles arranged at equal intervals are formed on the inner walls of the water receiving holes, and the water baffles are arranged axially along the water spraying jackets and protrude toward a central axis direction.

7. The rotating sprinkler head according to claim 6, wherein there are four water baffles arranged at equal intervals on the inner walls of the water receiving holes.
